(19) United States
(12) Patent Application Publication
(10) Pub. No.: US 2025/0248326 A1
(43) Pub. Date: Aug. 7, 2025

(54) SEED SPIKE AND PLANTER USING THE SAME

(71) Applicant: REENVISION AG, INC., Nora Springs, IA (US)

(72) Inventors: Jayson Ryner, Nora Springs, IA (US); Anthony Riesen, Nora Springs, IA (US); Wesley Tremmel, Nora Springs, IA (US)

(21) Appl. No.: 18/854,232

(22) PCT Filed: Apr. 5, 2023
(86) PCT No.: PCT/US23/17568

§ 371 Date: Oct. 4, 2024

Related U.S. Application Data
(60) Provisional application No. 63/327,601, filed on Apr. 5, 2022.
(60) Provisional application No. 63/374,808, filed on Sep. 7, 2022.

(51) Int. Cl. A01C 7/00; A01C 7/20

(52) U.S. Cl. CPC A01C 7/002; A01C 7/206

(57) ABSTRACT

Disclosed is a seed spike assembly may include a body having an inclined back side and a front side that connect to form a substantially pointed end, the body including a first channel configured to receive an agricultural seed and a second channel that intersects the first channel and receives the seed from the first channel, the second channel having an opening through which the seed may exit the body; and a slider in the second channel, the slider having a pointed end and configured to slide into a first position to block a seed from entering the second channel from the first channel, a second position to allow the seed the enter the second channel, and a third position where the slider extends out of the second channel near the pointed end.

### BACKGROUND

### 1. Field

Example embodiments relate to a seed spike and a planter using the same.

### 2. Description of the Related Art

Seed dibblers were devised centuries ago to aid in the planting of seeds. Ancient seed dibblers were as simple as a sharp stick carried by a worker; the worker simply stabbed the sharp end into the ground to a desired depth, then dropped in a seed in the indentation, and thereafter covered the seed with dirt. However, the inefficiencies of planting large fields by hand using seed dibblers is impractical. Instead, modern farming techniques generally use a tractor to move a planter which includes an opener to open the ground, a mechanism to drop seed into the opened ground, and a closer to cover the seed with soil. While such planters have greatly improved crop yields they are not without their problems. For example, modern tillage practices often result in poor soil health, damage to organic matter, excessive erosion, and soil compaction. Additionally, fuel, labor, and equipment associated with tilling soil also adds significant cost to farming operations.

### SUMMARY

The inventor set out to develop a planting technique which does not include the problems associated with modern tilling operations. As a result, the inventor developed a seed spike configured to plant a seed in soil with minimal soil disruption. The seed spike generally includes a solid body having a pointed end which can be inserted into the ground. The seed spike includes a first channel into which a seed can be deposited and a second channel in communication with the first channel. The second channel may enclose a slider which may move through the second channel. In one configuration the slider is arranged to prevent a seed from entering the second channel from the first channel while preventing soil and/or debris from entering the second channel when the seed spike is inserted into the ground. In another configuration the slider may be displaced to allow the seed to enter the second channel from the first channel and fall to the ground via the second channel. In yet another configuration, the slider may be moved so the slider can press the seed into the soil to create seed/soil contact while, at the same time, removing any soil and/or debris that may have entered to the seed spike when the seed spike was inserted into the ground. Such a seed spike may be part of a larger assembly having a plurality of seed spikes for planting a plurality of seeds in the ground without having the problems associated with modern tilling operations. For example, planting seeds using the invention described herein will reduce damage to soil, soil erosion, and compaction which is typically associated with modern tilling techniques. Additionally, implementing the invention disclosed herein requires less power than is generally required by modern tilling operations which require pulling an opener through the ground to open the ground to plant seed.

In at least one example embodiment, a seed spike assembly may include a seed spike having a first channel and a second channel in communication with one another, a funnel configured to provide seed to the first channel, a slider in the second channel, a crank wheel, and a connecting rod connecting the crank wheel to the slider, wherein as the slider is moved the first channel is one of blocked by the slider and exposed by the slider.

In at least one example embodiment, a seed spike assembly may include a body having an inclined back side and a front side that connect to form a substantially pointed end, the body including a first channel configured to receive an agricultural seed and a second channel that intersects the first channel and receives the seed from the first channel, the second channel having an opening through which the seed may exit the body; and a slider in the second channel, the slider having a pointed end and configured to slide into a first position to block a seed from entering the second channel from the first channel, a second position to allow the seed the enter the second channel, and a third position where the slider extends out of the second channel near the pointed end.

In at least one nonlimiting example embodiment, a method of planting a seed may include pushing a seed spike assembly into the ground, the seed spike assembly having a body with an inclined back side and a front side that connects to the inclined back side to form a substantially pointed end, the body including a first channel with a seed and a second channel that intersects the first channel, the seed spike assembly further including a slider in the second channel in a position which blocks soil from entering the second channel and blocks the seed from entering the second channel; moving the slider in the second channel to allow the seed to enter the second channel and drop into the soil; and moving the slider in the second channel to push the seed into the soils to create seed soil contact and clear out any debris in the second channel.

### BRIEF DESCRIPTION OF THE DRAWINGS

Example embodiments are described in detail below with reference to the attached drawing figures, wherein:

FIG. 1 is a first perspective view of a seed spike assembly in accordance with a nonlimiting example of the invention;

FIG. 2 is a second perspective view of a seed spike assembly in accordance with a nonlimiting example of the invention;

FIG. 3 is a first section view of a seed spike assembly in accordance with a nonlimiting example of the invention;

FIG. 4 is a third perspective view of a seed spike assembly in accordance with a nonlimiting example of the invention;

FIG. 5 is a fourth perspective view of a seed spike assembly in accordance with a nonlimiting example of the invention;

FIG. 6 is a second section view of a seed spike assembly in accordance with a nonlimiting example of the invention;

FIG. 7 is a fifth perspective view of a seed spike assembly in accordance with a nonlimiting example of the invention;

FIG. 8 is a sixth perspective view of a seed spike assembly in accordance with a nonlimiting example of the invention;

FIG. 9 is a third section view of a seed spike assembly in accordance with a nonlimiting example of the invention;

FIG. 10 is a seventh perspective view of a seed spike assembly in accordance with a nonlimiting example of the invention;

FIG. 11 is an eight perspective view of a seed spike assembly in accordance with a nonlimiting example of the invention;

FIG. 12 is a fourth section view of a seed spike assembly in accordance with a nonlimiting example of the invention;

FIG. 13 is a partial view of a planter using a plurality of seed spike assemblies;

FIG. 14 is a perspective view of a spike orientation wheel having a plurality of seed spike assemblies;

FIG. 15 is a section view of the spike orientation wheel having the plurality of seed spike assemblies;

FIG. 16 is a perspective view of a planter using the seed spike assemblies in accordance with a nonlimiting example of the invention;

FIG. 17 is another view of the planter using the seed spike assemblies in accordance with a nonlimiting example of the invention;

FIG. 18 is side view of the planter using the seed spike assemblies in accordance with a nonlimiting example of the invention;

FIGS. 19A-19E illustrate inventive concepts associated with a seed spike body;

FIG. 21 illustrates an example of a slider entering a seed spike body; and

FIG. 22 illustrates a nonlimiting example of a seed spike body.

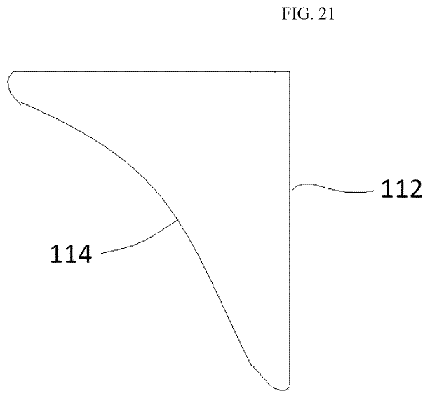

### DETAILED DESCRIPTION

Example embodiments will now be described more fully with reference to the accompanying drawings. Example embodiments are not intended to limit the disclosure since the disclosure may be embodied in different forms. Rather, example embodiments are provided so that this disclosure will be thorough and complete, and will fully convey the scope of the disclosure to those skilled in the art. In the drawings, the sizes of components may be exaggerated for clarity.

In this application, when a first element is described as being “on” or “connected to” a second element, the first element may be directly on or directly connected to the second element or may be on or connected to an intervening element that may be present between the first element and the second element. When a first element is described as being “directly on” or “directly connected to” a second element, there are no intervening elements. In this application, the term “and/or” includes any and all combinations of one or more of the associated listed items.

In this application, spatially relative terms merely describe one element's relationship to another. The spatially relative terms are intended to encompass different orientations of the structure. For example, if a first element of a structure is described as being “above” a second element, the term “above” is not meant to limit the disclosure since, if the structure is turned over, the first element would be “beneath” the second element. As such, use of the term “above” is intended to encompass the terms “above” and “below”. The structure may be otherwise oriented (rotated 90 degrees or at other orientations) and the spatially relative descriptors used herein interpreted accordingly.

Example embodiments are illustrated by way of ideal schematic views. However, example embodiments are not intended to be limited by the ideal schematic views since example embodiments may be modified in accordance with manufacturing technologies and/or tolerances.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Example embodiments relate to a seed spike and a planter using the same.

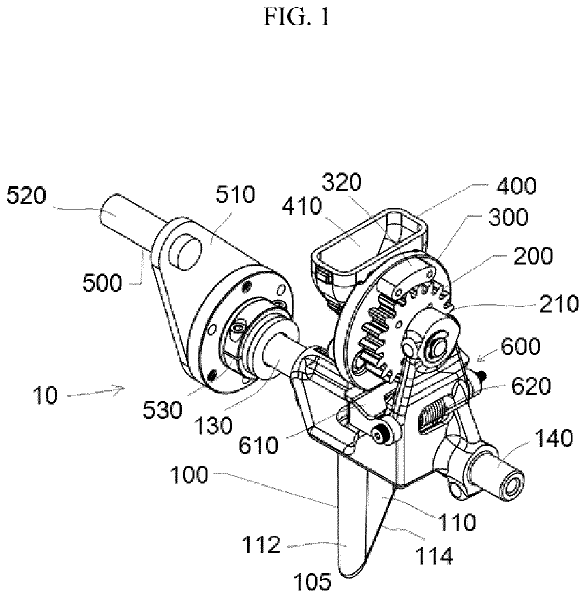

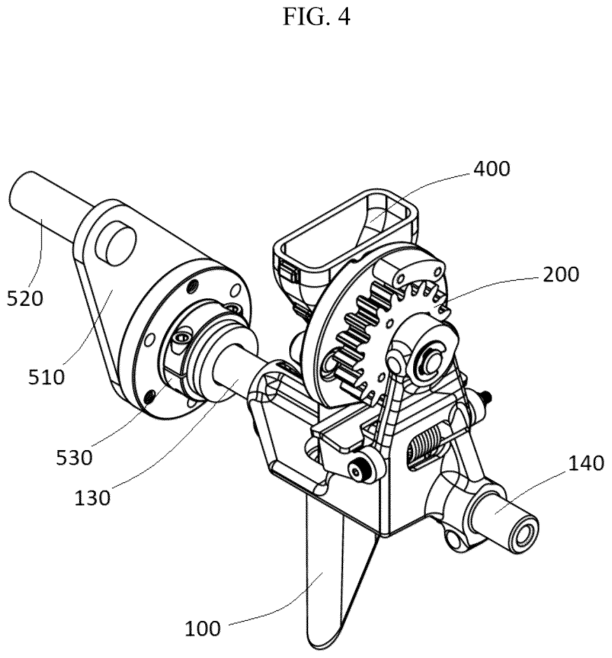

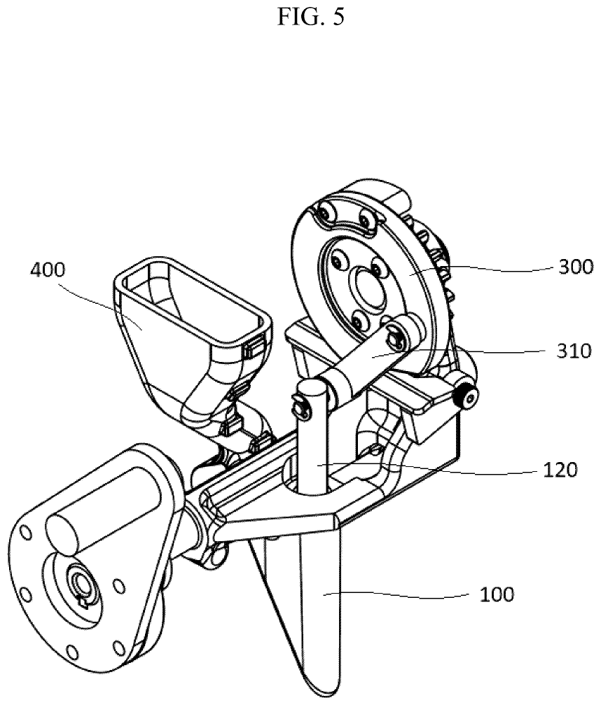

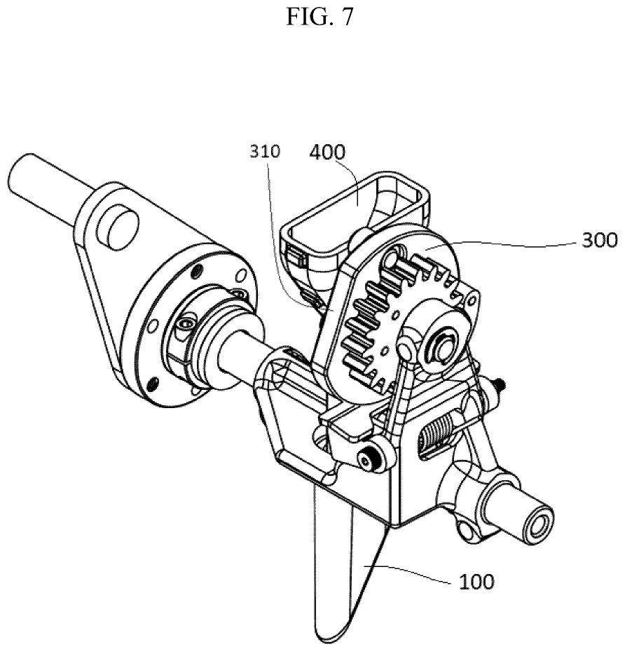

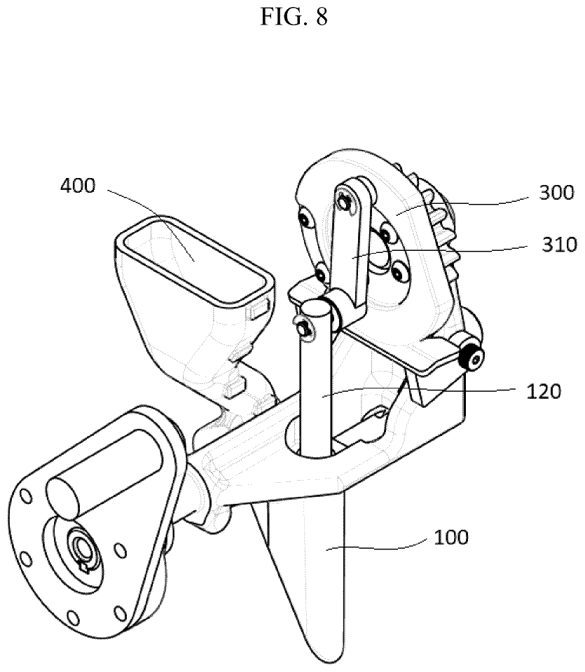

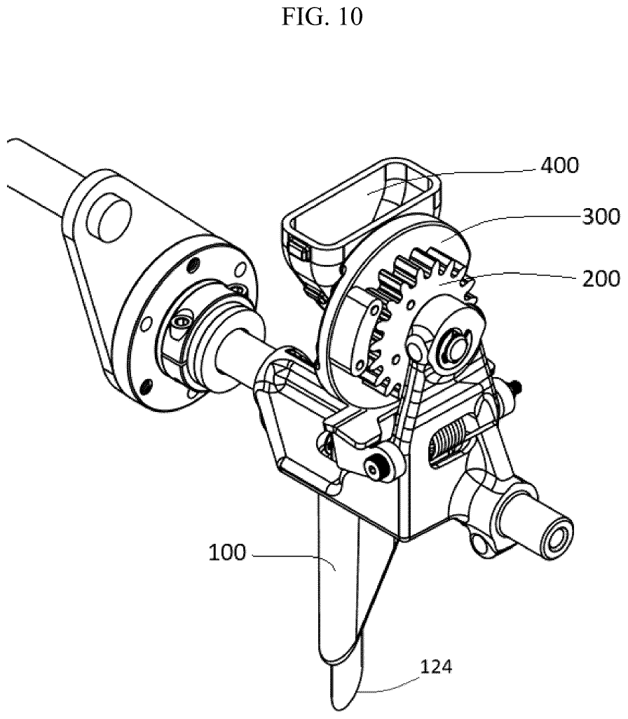

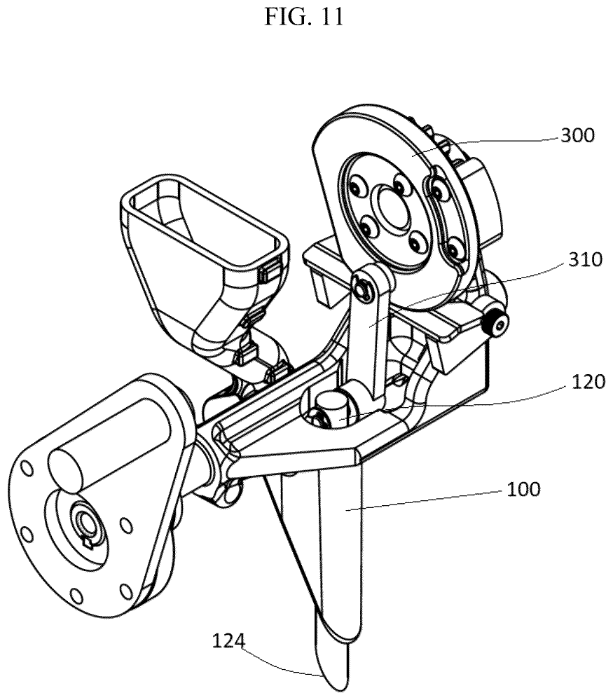

FIGS. 1-12 are various views of a seed spike assembly 10 in accordance with a nonlimiting example of the invention. As shown in FIGS. 1-12, the example seed spike assembly 10 generally includes a seed spike 100, a driven gear 200, a crank wheel 300, a seed funnel 400, an orientation shaft 500, and a spring assembly 600. It is understood this example of a seed spike assembly 10 is for purposes of illustration only and is not meant to limit the invention as the invention may be captured in various embodiments.

Referring to FIGS. 1-12 the seed spike 100 generally includes a solid body 110 having a pointed end 105. That is, in the nonlimiting embodiment of FIGS. 1-12 the solid body 110 has a generally vertical front side 112 and an inclined back side 114 which form a somewhat pointed end 105. Having a pointed end 105 allows the seed spike 100 to penetrate the ground. While the angle of the back side 114 is not critical, having an angle Φ somewhat larger than 45 degrees may be preferred in some applications. In addition, the front side 112 is not required to be vertical as it could be inclined as well.

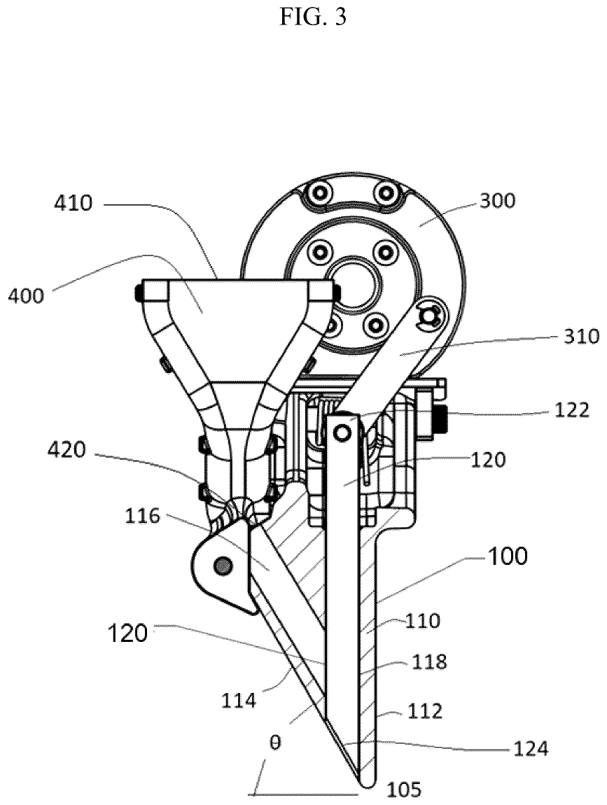

In example embodiments, while the body 110 of the seed spike 100 may be substantially solid, the body 110 may have a first channel 116 into which a seed from the seed funnel 400 may be received (see FIG. 3 which is a cross-section of the seed spike assembly 10). The example body 110 may also have a second channel 118 through which a slider 120 may pass. Each of the channels 116 and 118 may resemble cylindrical channels that intersect each other near the end 105. As such, the channels 116 and 118 are in communication with each other. As will be explained shortly, the seed may enter the seed spike 100 via the first channel 116 and exit the seed spike 100 via the second channel 118. In addition, the slider 120 may block the seed from entering the second channel 118 but then be moved to allow the seed to enter the second channel 118 and exit the seed spike 100 via the second channel 118. Further yet, the slider 120 may be controlled so that an end of the slider 120 pushes out of the body 110 near or at the pointed end 105 to press the seed into the soil thereby increasing soil to seed contact. As one skilled in the art can appreciate, although channels 116 and 118 have been described as cylindrical channels, the profile of the channels 116 and 118 can vary from one embodiment to another. For example, rather than resembling cylindrical channels, the cross-sections of the channels 116 and 118 may be square, elliptical, rectangular, or polygon shaped.

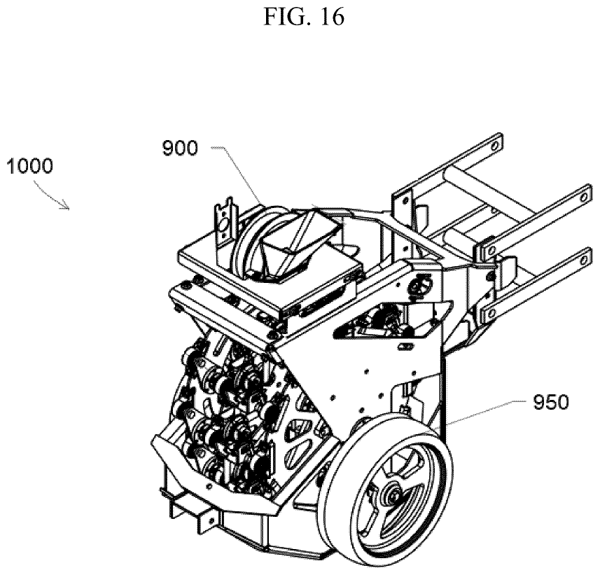

In example embodiments the seed funnel 400 generally has a hollow body having a first open end 410 to receive a seed from a seed dispenser 900 (such as a seed meter, see FIG. 16), and a second open end 420 through which the seed leaves the seed funnel 400 and enters the seed spike 100. More specifically, the seed that exits the seed funnel 400 enters into the first channel 116 of the seed spike 100. The first open end 410 may be larger than the second open end 420 to ensure the seed is received from the seed dispenser 900 and may have sloped and narrowing surfaces to make sure the seed is properly directed into the first channel 116 of the seed spike 100.

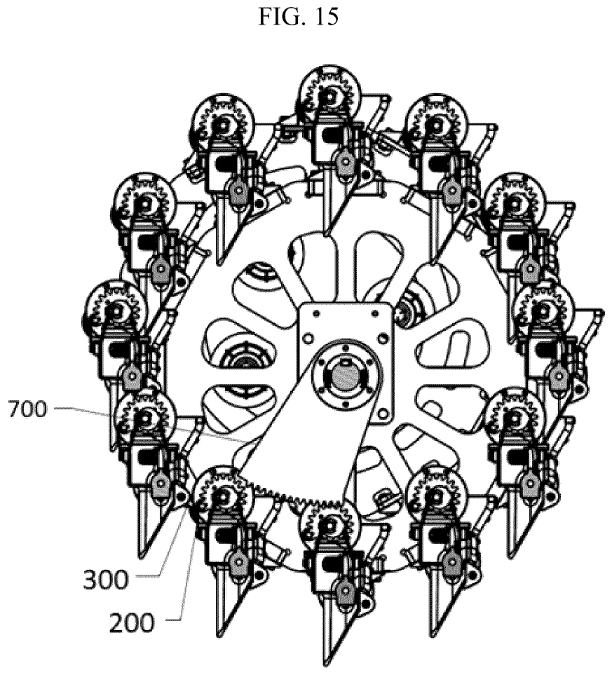

In example embodiments, the crank wheel 300 and the driven gear 200 may be connected to one another and, in some embodiments, may be part of a unitary structure. In example embodiments the driven gear 200 may have teeth 210 which engage a driver gear 700 (see FIG. 15) which may be part of a larger unit 1000. When the teeth 210 of the driven gear 200 engage the driver gear 700 the driven gear 200 rotates thus causing the crank wheel 300 to also rotate.

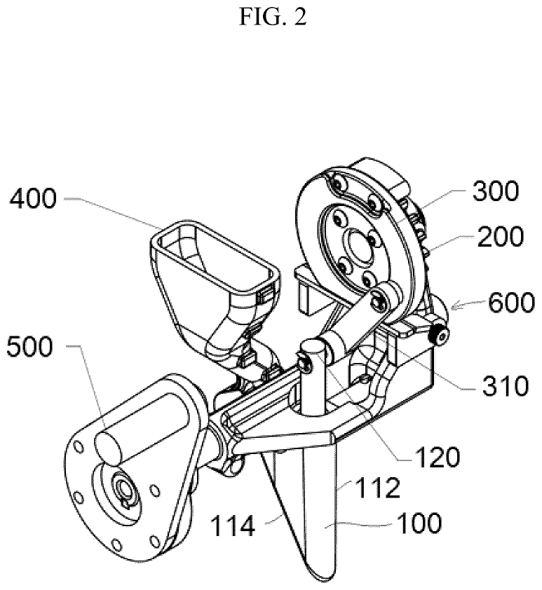

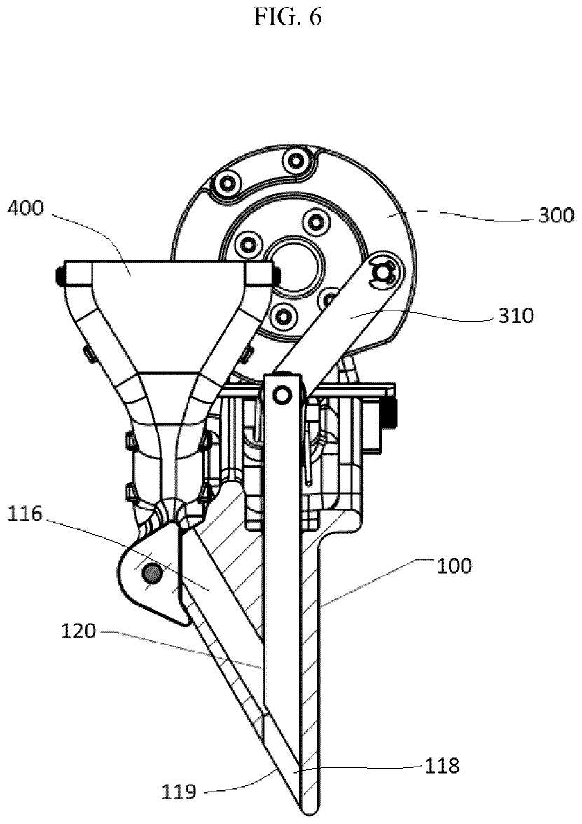

Referring more specifically to FIG. 2, the example seed spike assembly 10 includes a connecting rod 310 which connects the crank wheel 300 to the slider 120. In the nonlimiting example of FIGS. 1-12, a first end of the connecting rod 310 may be pin connected to the crank wheel 300 and a second end of the connecting rod 310 may be pin connected to the slider 120 at a first end 122 of the slider 120. Thus, when the crank wheel 300 rotates the connecting rod 310 causes the slider 120 to move up and down within the second channel 118. For example, as shown in FIG. 3, the slider 120 is shown in a somewhat downward position where the slider 120 covers an end of the first channel 116. As such, when in the configuration of FIG. 3, any seed in the first channel 116 is prevented from entering the second channel 118 by the slider 120. FIG. 6, however, shows the slider 120 drawn upward to partially expose the end of the first channel 116.

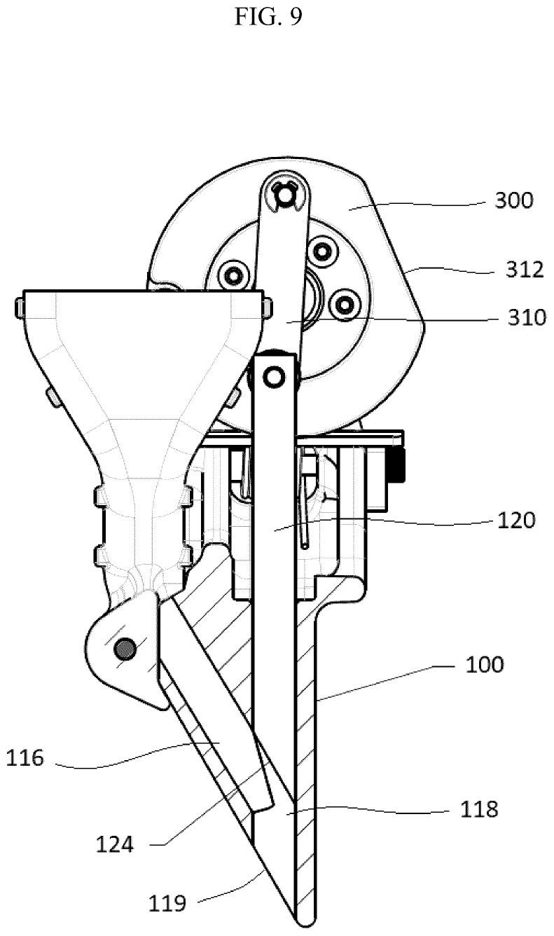

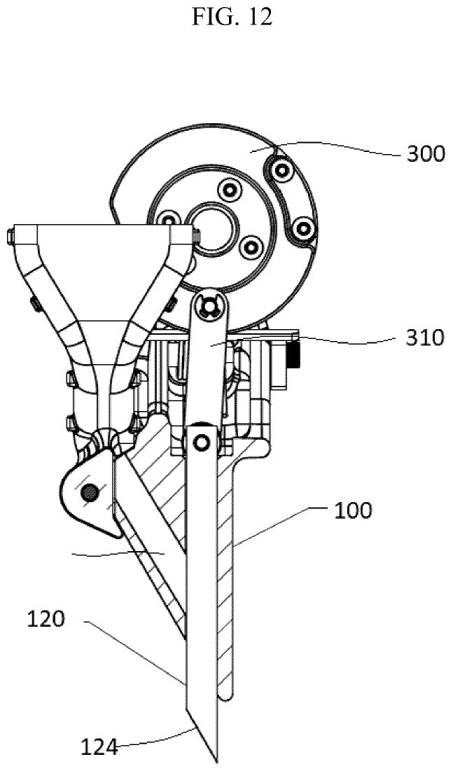

FIG. 9 shows the slider 120 drawn even further upward to generally expose the end of the first channel 116. That is, in FIG. 9, the slider 120 is drawn upwards allowing a seed in the first channel 116 to enter the second channel 118. FIG. 12 shows the slider 120 pushed downward so that a second end 124 of the slider 120 actually exits (or nearly exits) the seed spike 100. Thus, by controlling the slider 120 the end of the first channel 116 can be blocked, as shown in FIG. 3, partially exposed as shown in FIG. 6, substantially exposed (if not completely exposed) as shown in FIG. 9. Further, the slider 120 may be controlled so that the second end 124 of the slider 120 may actually exit the seed spike 100. As one skilled in the art would understand, in the nonlimiting example of FIGS. 1-12, the position of the slider 120 may be controlled by the crank wheel 300 connected to the driven gear 200 via the connecting rod 310.

In example embodiments the slider 120 may resemble a cylinder. In one embodiment, the first end 122 of the slider 120 includes hole, a slot, or a depression to receive a pin, a screw, or some other member to connect the slider 120 to the connecting rod 310. In another embodiment, rather than having a hole, slot, or depression to receive a pin, the first end 122 of the slider 120 includes a protrusion which inserts into a hole, a slot, or a depression of the connecting rod 310 to form the pin connection. Regardless, the first end 122 of the slider 120 may be configured to have a pin-type connection with the connecting rod 310. The second end 124 of the slider 120 may, in one embodiment, be sloped. That is, the second end 124 may have an inclined surface as shown in the figures. The inclined surface may allow the second end 124 of the slider 120 to penetrate the ground easier than if it were horizontal. In addition, providing an inclined surface applies a force to a seed to move the seed not only in a downward direction, but a side ways direction as well. This may prevent the seed from being crushed and may move the seed into a region of soil which is not compacted. In addition, having an inclined surface may increase the surface area to allow for less stress to be imparted to a seed when the seed spike assembly 10 is in use. While the figures show the second end 124 of the slider 120 as being substantially flat it is understood the end 124 may have another profile. For example, the second end 124, rather than being flat, may actually be arc shaped or have some other suitable shape.

In example embodiments the orientation shaft 500 may include a body 510 which may resemble a plate. The body 510 may have a shaft 520 extending therefrom which may be received in a bearing of a spike orientation wheel. The shaft 520 may, for example resemble a cylinder. The body 510 may also include a shaft receiving structure 530 which may be configured to receive a first shaft 130 of the seed spike 100. In example embodiments, the shaft receiving structure 530 may capture the first shaft 130 in a manner that allows the first shaft 130 to rotate therein. In another embodiment, the shaft receiving structure 530 may capture the first shaft 130 in a way that doesn't allow the first shaft 130 to rotate. In example embodiments, the seed spike 100 may further include a second shaft 140 which may be captured by another bearing of the spike orientation wheel. As shown in example embodiments, the shaft 520 and the shaft 140 may be parallel but offset from one another.

In example embodiments the spring assembly 600 may include a plate 610 and a spring 620 which biases the plate 610. The plate 610 may contact and stabilize the crank wheel 300. More specifically, the crank wheel 300 may have an interfacing surface 312 upon which the plate 610 presses against. The plate 610 helps stabilize the crank wheel 300. However, when the driver gear 700 contacts the crank wheel's contact block 320 the crank wheel 300 is rotated causing the plate 610 to pivot or move downward as the crank wheel 300 rotates. However, when the crank wheel 300 becomes disengaged from the driver gear 700 the interfacing surface 312 again becomes aligned with the plate 610 and the plate 610 rotates or moves upwards to contact the interfacing surface 312 to stabilize the crank wheel 300.

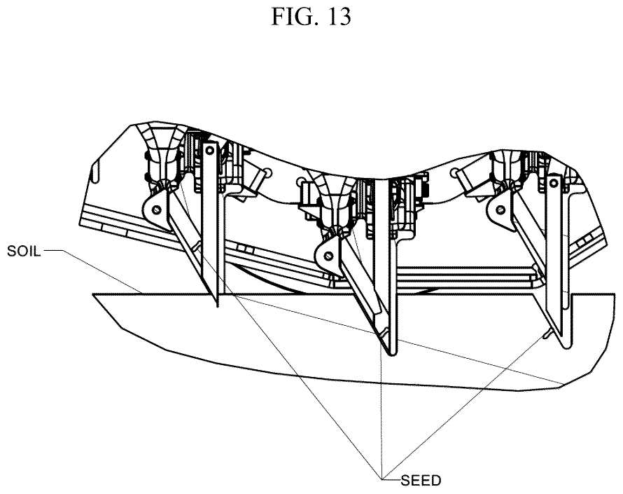

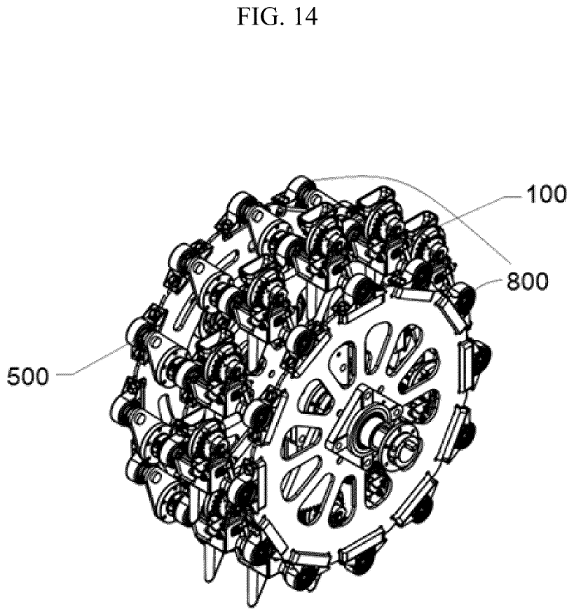

Referring to FIGS. 14-15 it is shown a plurality of seed spike assemblies 10 may be supported by a pair of plates having the aforementioned bearings and between the plates. In FIGS. 14-15 twelve seed spike assemblies 10 are shown attached to a left side plate and a right side plate. FIG. 15 is a section view showing shows the driver gear 700 between the plates. In the examples shown the driver gear 700 remains motionless compared to the plurality of seed spike assemblies 10 which rotate as the pair of plates rotate. As the plates are rotated relative to the driver gear 700 the teeth 210 of the driven gears 200 mesh with the teeth of the driver gear 700. This causes the driven gears 200 and the crank wheels 300 to rotate thereby causing the connecting rods 310 to move the sliders 120. The leftmost seed spike assembly 10 of FIG. 13, for example, shows the seed spike assembly 10 having it's slider 120 in a position which blocks a seed from exiting its first channel 116. In this position the slider 120 is also arranged so the second end 124 of the slider 120 blocks any debris or soil from entering the second channel 118. The middle seed spike assembly 10 of FIG. 13 shows the slider 120 pulled upwards thereby allowing the seed to fall through the first channel 116 and the second channel 118 and into the ground via a hole 119 in the body 100. The rightmost seed spike assembly 10 of FIG. 13 shows the slider 120 pushed downwards and into the soil to create greater seed soil contact. In this position the slider 120 also pushes out any soil that may have entered the second channel 118. Additionally, due to the inclined surface of the slider 120, the seed is not pushed directly downwards, rather, it is a sideways motion as well as a downwards motion. This allows the seed to be pushed into soil which may be uncompacted.

As shown in FIGS. 14-15 each of the seed spike assemblies 10 may be arranged so that the seed spikes 100 are substantially vertical and remain vertical as the plates which support them rotate. This is due to the fact that shafts 520 and 140 are offset from one another and are arranged to promote a substantially vertical orientation of the seed spike assemblies 10.

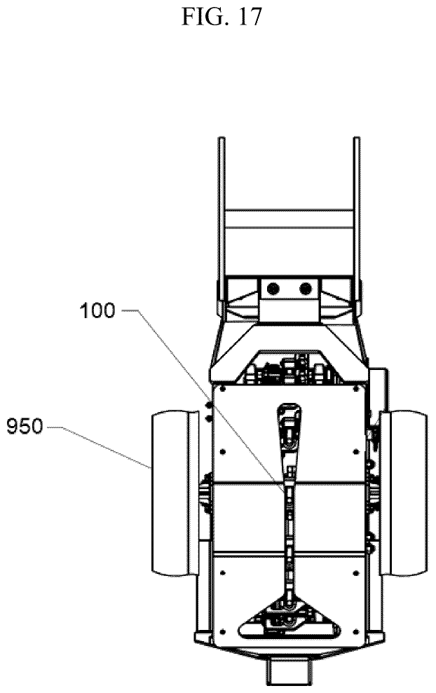

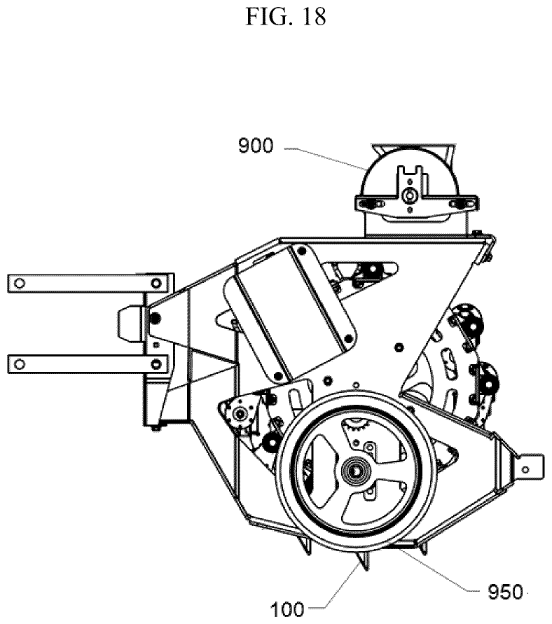

FIGS. 16-18 illustrate the seed spike assemblies 10 incorporated into a row unit having gauge wheel 950 to control a depth at which the seeds may be planted along with a seed meter which may operate as a seed dispenser.

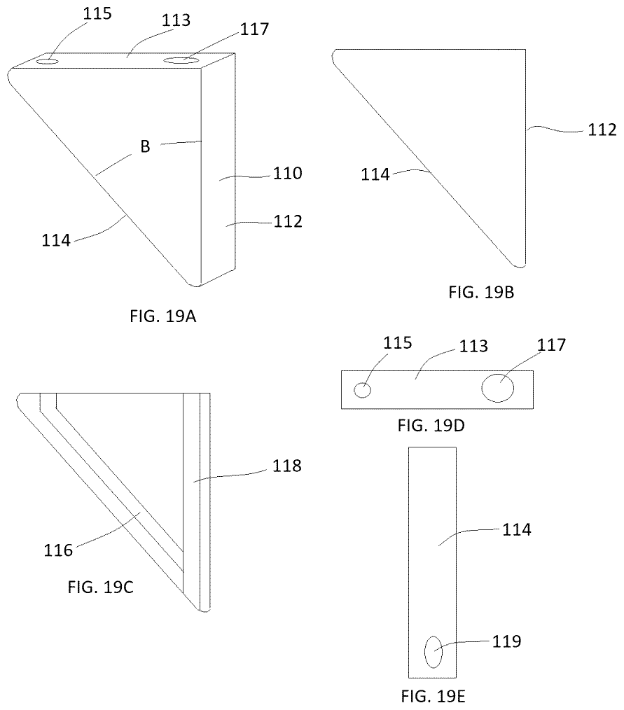

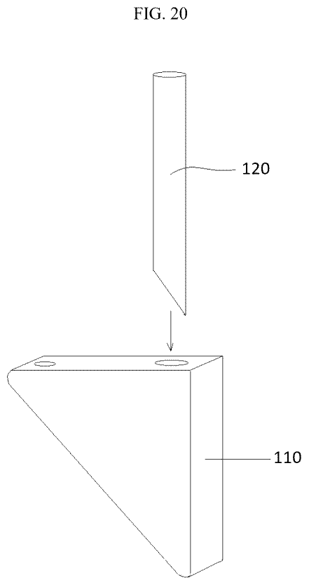

Thus far, various aspects of seed spike assemblies 10 have been shown. FIGS. 19A-19E show generalized aspects of a seed spike body 110. It is understood the teachings associated with FIGS. 19A-19E are not meant to limit the invention but to merely show some inventive concepts. FIG. 19A for example, shows a perspective view of an exemplary/generalized seed spike body 110 having an inclined backside 114 and a front side 112 which may be, but is not required to be, vertical. The angle B between the inclined backside 114 and the front side 112 may be, but is not required to be, 45 degrees or less to promote ground penetration of the seed spike body 110. The seed spike body 110 may be a substantially integral structure with a couple of channels 116 and 118 as previously described. Associated with the seed spike body 110 are apertures 115 and 117 which may be on a surface 113 of the seed spike body 110. Aperture 115, for example, be associated with the first channel 116 and aperture 117 may be associated with the second channel 118. This teaching shows the seed spike body 110 may have apertures configured to allow seed into the first channel 116 via the aperture 115 (for example, receive seed from the seed funnel 400) and the slider 120 may enter the seed spike body 110 via the aperture 117. While apertures 115 and 117 are shown as being on the same surface 113, this is not meant to limit the invention as the apertures 115 and 117 may be on different surfaces. FIG. 19E shows the second channel 118 may terminate at aperture 119 which may be formed through the inclined backside 114. FIG. 20 shows that the slider 120 may enter the seed spike body 110 via the aperture 117 which may be at a surface 113 of the seed spike body 110. FIG. 21 shows a variant of the generalized seed spike body 110 where the inclined back side 114 is somewhat curved, however, it is understood a curvature as shown in FIG. 21 falls within the general teaching of an inclined backside.

What I claim is:

1. A seed spike assembly comprising:
a seed spike having a first channel and a second channel in communication with one another;
a funnel configured to provide seed to the first channel;
a slider in the second channel;
a crank wheel; and
a connecting rod connecting the crank wheel to the slider, wherein as the slider is moved the first channel is one of blocked by the slider and exposed by the slider.

2. The seed spike assembly of claim 1, wherein the slider is configured to protrude outside of the seed spike.

3. The seed spike assembly of claim 1, wherein the seed spike includes a back side and a front side which join to form a substantially pointed end.

4. The seed spike assembly of claim 1, wherein the seed spike includes a back side which is inclined and a front side which join together to form a substantially pointed end.

5. The seed spike assembly of claim 1, wherein the seed spike includes a back side which is inclined and a substantially vertical front side which join together to form a substantially pointed end.

6. The seed spike assembly of claim 5, wherein the back side is inclined from the horizontal at least 45 degrees.

7. The seed spike assembly of claim 1, wherein an end of the slider is pointed.

8. A seed spike assembly comprising:
a body having an inclined back side and a front side that connect to form a substantially pointed end, the body including a first channel configured to receive an agricultural seed and a second channel that intersects the first channel and receives the seed from the first channel, the second channel having an opening through which the seed may exit the body; and
a slider in the second channel, the slider having a pointed end and configured to slide into a first position to block a seed from entering the second channel from the first channel, a second position to allow the seed the enter the second channel, and a third position where the slider extends out of the second channel near the pointed end.

9. Th seed spike of claim 8, wherein the inclined back side is inclined at least 45 degrees from the horizontal when the front side is vertical.

9. A method of planting a seed comprising:
pushing a seed spike assembly into the ground, the seed spike assembly having a body with an inclined back side and a front side that connects to the inclined back side to form a substantially pointed end, the body including a first channel with a seed and a second channel that intersects the first channel, the seed spike assembly further including a slider in the second channel in a position which blocks soil from entering the second channel and blocks the seed from entering the second channel;
moving the slider in the second channel to allow the seed to enter the second channel and drop into the soil; and
moving the slider in the second channel to push the seed into the soils to create seed soil contact and clear out any debris in the second channel.

10. The method of claim 9, wherein the slider has an inclined surface to move the seed in a sideways and downward direction as it is pressed into the soil by the slider.
